(19) United States
(12) Patent Application Publication
(10) Pub. No.: US 2025/0028674 A1
(43) Pub. Date: Jan. 23, 2025

(54) INSTRUCTION SET ARCHITECTURE FOR IN-MEMORY COMPUTING

(71) Applicant: Rain Neuromorphics Inc., San Francisco, CA (US)

(72) Inventors: Nawab Ali, Bellingham, WA (US); Muzaffer Kal, Redmond, WA (US); Ludmila Atanassova Levkova, Bethesda, MD (US); Alexander Almela Conklin, San Jose, CA (US)

(21) Appl. No.: 18/777,360

(22) Filed: Jul. 18, 2024

Related U.S. Application Data
(60) Provisional application No. 63/527,789, filed on Jul. 19, 2023.
(60) Provisional application No. 63/621,916, filed on Jan. 17, 2024.

(51) Int. Cl. G06F 15/78; G06F 9/30; G06F 17/16

(52) U.S. Cl. CPC G06F 15/7839; G06F 9/30036; G06F 17/16

(57) ABSTRACT

A method is described. A general-purpose (GP) processor configured to communicate with a single co-processor identifies a first compute engine. Each compute engine includes a compute-in-memory (CIM) hardware module. The CIM hardware module stores weights corresponding to a matrix and performs a vector-matrix multiplication (VMM) of a vector and the matrix. First data is written to or loaded from the first compute engine by the GP processor. The method also includes identifying, by the GP processor, a second compute engine after the first data is written to and/or loaded from the first compute engine by the GP processor. Second data is written to and/or loaded from the second compute engine by the GP processor. The first data and the second data are for the weights, the vector, and/or a VMM for the first compute engine. The GP processor provides control and data movement for the compute engines.

### CROSS REFERENCE TO OTHER APPLICATIONS

This application claims priority to U.S. Provisional Patent Application No. 63/527,789 entitled INSTRUCTION SET ARCHITECTURE FOR IN-MEMORY COMPUTING filed Jul. 19, 2023 and U.S. Provisional Patent Application No. 63/621,916 entitled LOOK-UP TABLES FOR ARTIFICIAL INTELLIGENCE ACCELERATORS filed Jan. 17, 2024, both of which are incorporated herein by reference for all purposes.

### BACKGROUND OF THE INVENTION

Artificial intelligence (AI), or machine learning, utilizes learning networks (e.g. deep neural networks) loosely inspired by the brain in order to solve problems. Learning networks typically include layers of weights that weight signals (mimicking synapses) interleaved with activation layers that apply activation functions to the signals (mimicking neurons). Thus, a weight layer provides weighted input signals to an activation layer. Neurons in the activation layer operate on the weighted input signals by applying some activation function to the input signals and provide output signals corresponding to the statuses of the neurons. The output signals from the activation layer are provided as input signals to the next weight layer, if any. This process may be repeated for the layers of the network. Learning networks are thus able to reduce complex problems to a set of weights and the applied activation functions. The structure of the network (e.g., number of layers, connectivity among the layers, dimensionality of the layers, the type of activation function, etc.) are together known as a model. Learning networks can leverage hardware, such as graphics processing units (GPUs) and/or AI accelerators, which perform operations usable in machine learning in parallel. Such tools can dramatically improve the speed and efficiency with which data-heavy and other tasks can be accomplished by the learning network.

In order to be used in data-heavy tasks and/or other applications, the learning network is trained prior to its use in an application. Training involves optimizing a configuration of the high-dimensional and nonlinear set of weights. In other words, the weights in each layer are determined, thereby identifying the parameters of a model. Supervised training may include evaluating the final output signals of the last layer of the learning network based on a set of target outputs (e.g., the desired output signals) for a given set of input signals and adjusting the weights in one or more layers to improve the correlation between the output signals for the learning network and the target outputs. Once the correlation is sufficiently high, training may be considered complete. The model can then be deployed for use. Deploying the model may include copying the weights into a memory (or other storage) of the device on which the model is desired to be used. For example, the weights may be copied into the AI accelerator or storage for the GPU.

Although training can result in a learning network capable of solving challenging problems, determining solutions even with an optimized model may be time-consuming. Use of an AI accelerator may reduce the time required for the machine learning model to provide a solution. However, further improvements are desired. For example, an AI accelerator may only be optimized for general use, rather than for a particular model. As a result, performance of the learning network may be poorer than desired. In addition, a model may be desired to be re-trained for a different purpose and/or a different model may be desired to be used with the same AI accelerator. This may adversely impact efficiency of the AI accelerator and/or require in-situ training as well as inference. Accordingly, what is desired is an improved technique for training and/or using learning networks.

### BRIEF DESCRIPTION OF THE DRA WINGS

Various embodiments of the invention are disclosed in the following detailed description and the accompanying drawings.

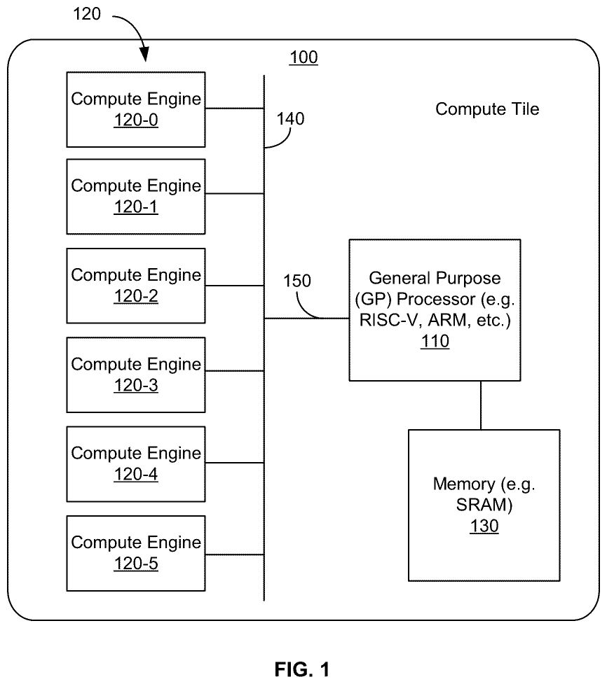

FIG. 1 is a diagram depicting an embodiment of a system usable in an AI accelerator and having an efficient architecture.

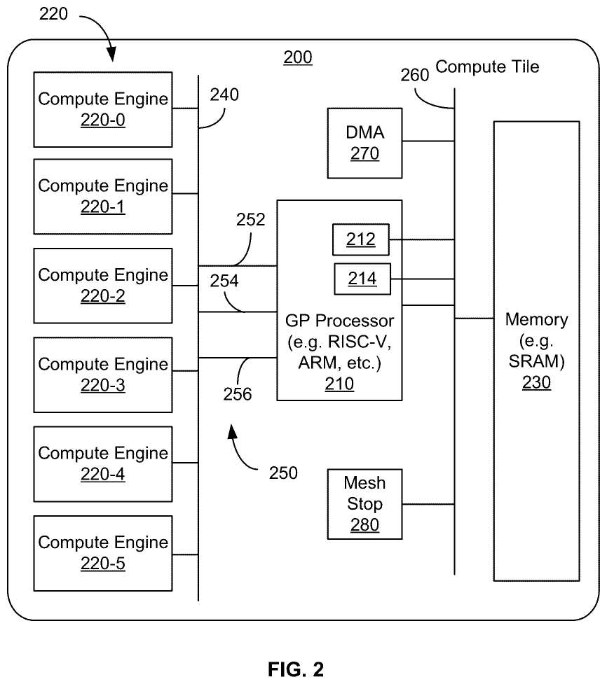

FIG. 2 depicts an embodiment of a system usable in an AI accelerator and having an efficient architecture.

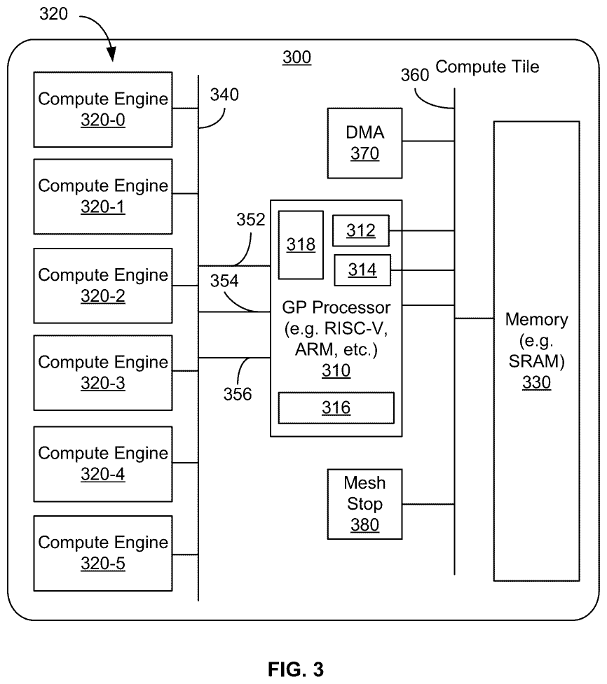

FIG. 3 depicts an embodiment of a system usable in an AI accelerator and having an efficient architecture.

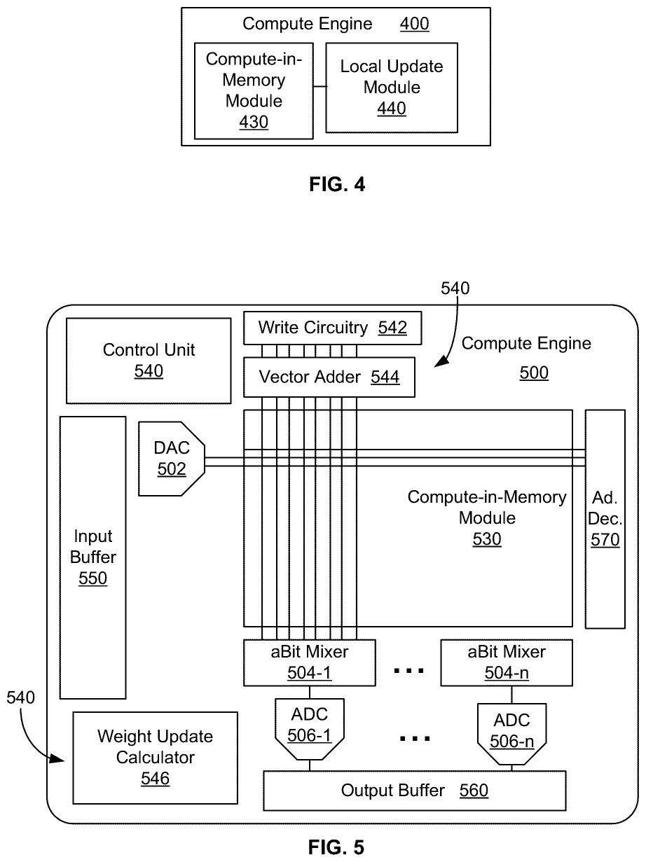

FIG. 4 depicts an embodiment of a portion of a compute engine usable in an AI accelerator.

FIG. 5 depicts an embodiment of a portion of a compute engine usable in an AI accelerator and capable of performing local updates.

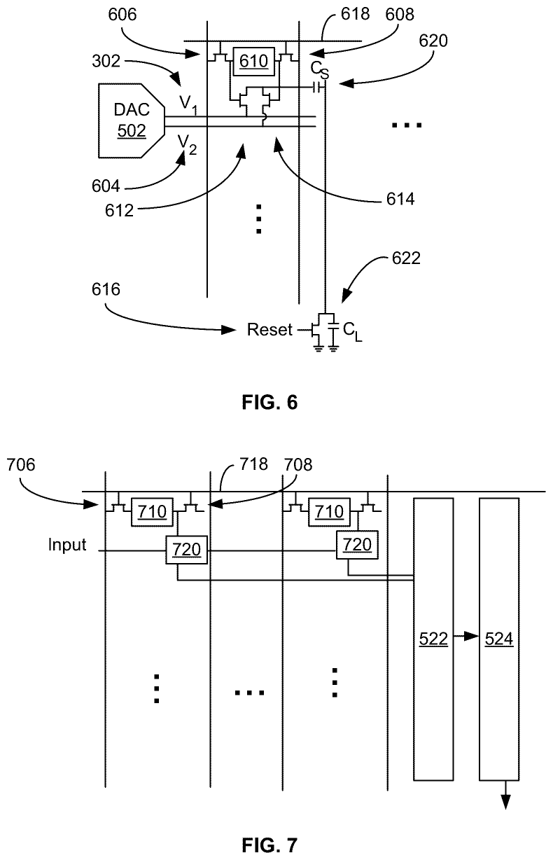

FIG. 6 depicts an embodiment of a portion of a compute-in-memory module usable in an AI accelerator. (SRAM)

FIG. 7 depicts an embodiment of a portion of a compute-in-memory module usable in an AI accelerator. (SRAM)

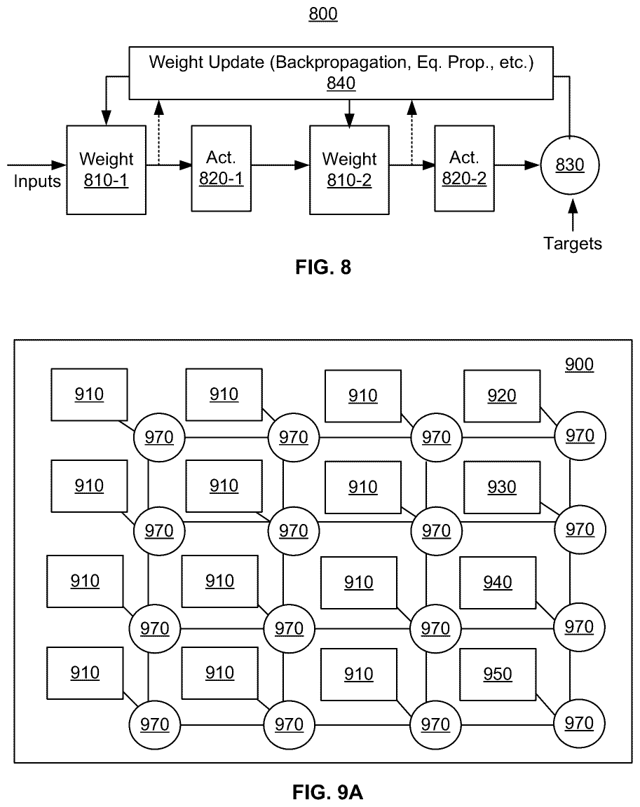

FIG. 8 depicts an embodiment of the data flow in a learning network.

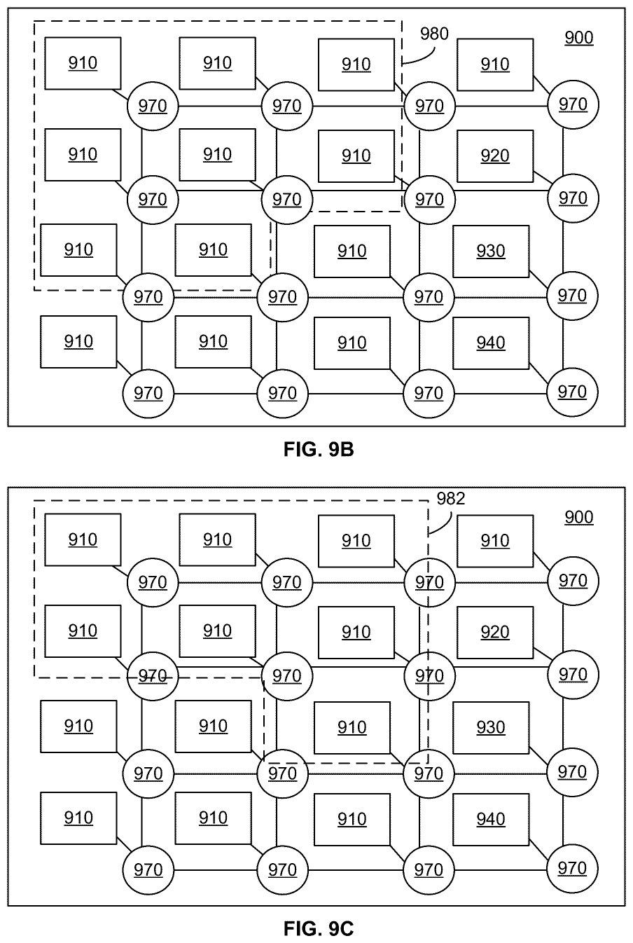

FIGS. 9A-9C depict an embodiment of an architecture including compute engines and usable in an AI accelerator.

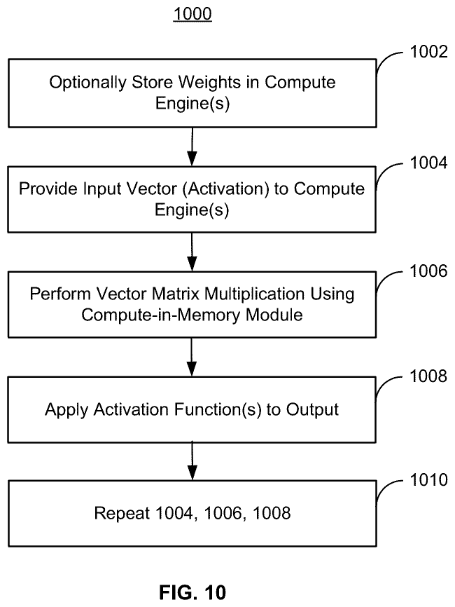

FIG. 10 is a flow chart depicting one embodiment of a method for using a compute engine usable in an AI accelerator for.

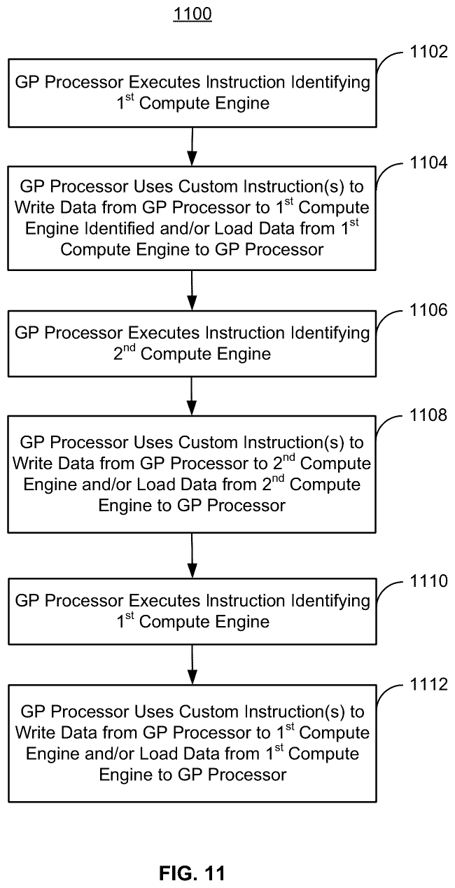

FIG. 11 is a flow chart depicting one embodiment of a method for using instructions to move data between a GP processor and a compute engine in an AI accelerator.

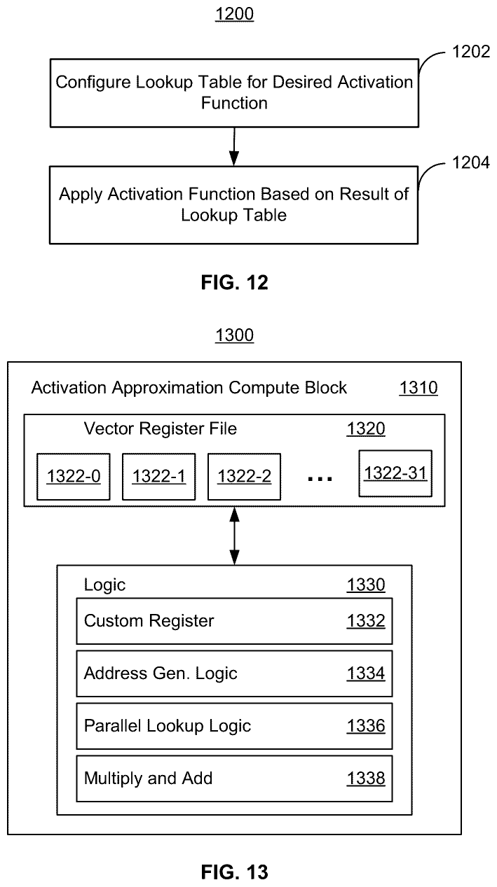

FIG. 12 is a flow chart depicting one embodiment of a method for using instructions to apply an activation function using a lookup table in an AI accelerator.

FIG. 13 is a block diagram depicting one embodiment of a method for using instructions to apply an activation function using a lookup table in an AI accelerator.

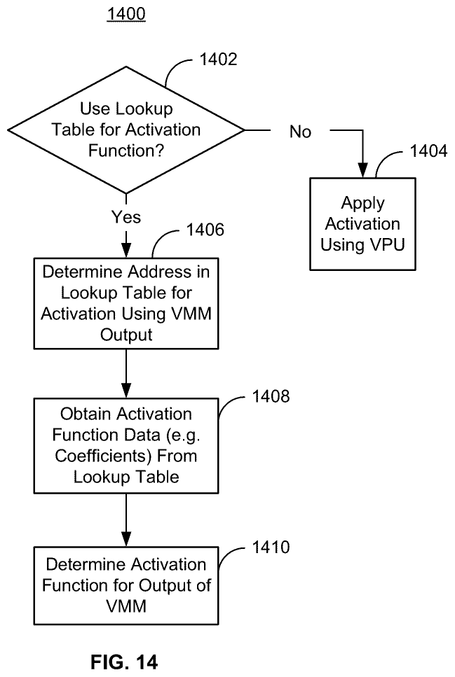

FIG. 14 is a flow chart depicting one embodiment of a method for using instructions to apply an activation function using a lookup table in an AI accelerator.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A method is described. The method includes executing, by a general-purpose (GP) processor configured to communicate with a single co-processor, an instruction identifying a first compute engine of a plurality of compute engines to the GP processor. Each compute engine includes a compute-in-memory (CIM) hardware module. The CIM hardware module is configured to store weights corresponding to a matrix in storage cells and to perform a vector-matrix multiplication (VMM) of a vector and the matrix. The compute engines are coupled with the GP processor. The method also includes at least one of writing first data to or loading the first data from the first compute engine by the GP processor. The first data is for at least one of the weights, the vector, or a first output of the VMM of the vector and the matrix for the first compute engine. The method also includes executing, by the GP processor, the instruction identifying a second compute engine of the compute engines to the GP processor after the at least one of the writing first data to or the loading the first data from the first compute engine by the GP processor. The method also includes at least one of writing second data to or loading the second data from the second compute engine by the GP processor. The second data is for at least one of the weights, the vector, or a second output of the VMM of the vector and the matrix for the second compute engine. The GP processor provides control and data movement for the plurality of compute engines.

In some embodiments, executing the instruction identifying the first compute engine further includes identifying a first address range of the first compute engine to the GP processor for the data movement. The writing the first data to and/or the loading the first data from the first compute engine further includes writing the first data to and/or loading the first data from the first address range of the first compute engine by the GP processor. In some embodiments, the writing the first data to and/or the loading the first data from the first compute engine includes writing the first data to the first compute engine. In such embodiments, the GP processor executes the instruction identifying the first compute engine after the writing to and/or loading from the second compute engine.

The method may include loading third data from the first compute engine by the GP processor. The third data is the output of the VMM of the vector and the matrix. In some such embodiments, the GP processor polls the first compute engine after the executing the instruction identifying the first compute engine and after the writing the second data to and/or the loading the second data. The loading the third data further includes the GP processor loading the third data from the first compute engine by the GP processor in response to the polling indicating the third data is available for loading.

In some embodiments, the GP processor applies an activation function to the first data from the first compute engine. Applying the activation function may include determining a resultant of the activation function applied to the first data based on information in a lookup table. In some embodiments, the GP processor includes vector register files. In some such embodiments, applying the activation function includes configuring the lookup table such that the lookup table resides in not more than two of the vector register files. In some embodiments, the lookup table is a piece-wise linear approximation lookup table.

A method is described. The method includes executing, by a GP processor, configured to communicate with a single co-processor, an instruction for identifying a first address range of a first compute engine of a plurality of compute engines. The address range is for data movement using the GP processor. Each of the compute engines included a CIM hardware module configured to store weights corresponding to a matrix and to perform a VMM of a vector and the matrix. The GP processor writes first data to and/or loads the first data from the first address range corresponding to the first compute engine. The first data is for at least one of the weights, the vector, or a first output of the VMM of the vector and the matrix for the first compute engine. The GP processor also executes the instruction identifying a second address range for a second compute engine of the compute engines. The GP processor writes second data to and/or loads the second data from the second address range corresponding to the second compute engine. The second data is for the weights, the vector, and/or a second output of the VMM of the vector and the matrix for the second compute engine. The GP processor executes the instruction identifying a third address range for the first compute engine after writing the second data to or loading the second data from the second address range. The GP processor loads third data from the third address range by the GP processor. The third data is for the output of the VMM of the vector and the matrix for the first compute engine. The GP processor applies to the third data from the third address range of the first compute engine, an activation function using a lookup table.

A compute tile includes a GP processor and compute engines coupled to the GP processor. Each of the compute engines includes a CIM hardware module that stores weights corresponding to a matrix and is configured to perform a VMM for the matrix. The GP processor provides control instructions and data to the plurality of compute engines. The GP processor is configured to execute an instruction identifying a first compute engine of the compute engines to the GP processor. The GP processor is also configured to write first data to and/or load the first data from the first compute engine. The first data is for the weights, the vector, and/or a first output of the VMM of the vector and the matrix for the first compute engine. The GP processor is also configured to execute the instruction identifying a second compute engine of the plurality of compute engines to the GP processor after the write and/or load of the first data to or loading the first data from the first compute engine. The GP processor is configured to write second data to and/or load the second data from the second compute engine. The second data is for at least one of the weights, the vector, or a second output of the VMM of the vector and the matrix for the second compute engine. Thus, the GP processor provides control and data movement for the plurality of compute engines. The GP processor may be coupled with the compute engines via a streaming port configured to exchange data between the GP processor and the compute engines.

In some embodiments, the GP processor executes the instruction identifying the first compute engine by identifying a first address range of the first compute engine to the GP processor for the data movement. To perform the write and/or load of the first data, the GP processor is further configured to write the first data to and/or load the first data from the first address range of the first compute engine.

In some embodiments, the GP processor writes the first data to the first compute engine. In some such embodiments, the GP processor is further configured to execute the instruction identifying the first compute engine after the writing and/or loading of the second data. In such embodiments, the GP processor may also be configured to load third data from the first compute engine, the third data being for the output of the VMM of the vector and the matrix.

In some embodiments, the GP processor is further configured to poll the first compute engine after executing the instruction identifying the first compute engine and after the writing and/or loading of the second data. In such embodiments, to load the third data, the GP processor may be further configured to load the third data from the first compute engine in response to the polling indicating the third data is available for loading. In some embodiments, the GP processor is coupled with the compute engines via a streaming port and a command port. The streaming port is configured to exchange data between the GP processor and the compute engines. The command port is configured for the GP processor to send commands to the plurality of compute engines.

In some embodiments, the GP processor is further configured to apply to the first data loaded from the first compute engine, an activation function. To apply the activation function, the GP processor may be configured to determine a resultant of the activation function applied to the first data based on information in a lookup table. In some embodiments, The GP processor includes vector register files. In some such embodiments, the GP processor configures the lookup table such that the lookup table resides in not more than two register files of the plurality of vector register files. In some such embodiments, the lookup table is a piece-wise linear approximation lookup table. In some embodiments, the lookup table is in the GP processor. For example, the lookup table may be in registers of the GP processor.

FIG. 1 is a diagram depicting an embodiment of system 100 usable in a learning network. System 100 is a compute tile and may be considered to be an artificial intelligence (AI) accelerator having an efficient architecture. Compute tile (or simply “tile”) 100 may be implemented as a single integrated circuit. Compute tile 100 includes a general purpose (GP) processor 110 and compute engines 120-0 through 120-5 (collectively or generically compute engines 120). Although six compute engines 120 are shown, in other embodiments another number may be included. GP processor 110 is shown as being coupled with compute engines 120 via compute bus (or other connector) 140, and bus 150. In other embodiments, GP processor 110 may be connected with compute engines 120 in another manner. In some embodiments, compute tile 100 may include on-tile memory 130. In other embodiments, memory 130 may be omitted. Other components, for example a cache or another additional memory, module(s) for applying activation functions, modules for moving data, and/or other modules, may be present in compute tile 100 in some embodiments.

GP processor 110 is a reduced instruction set computer (RISC) processor. For example, GP processor 110 may be a RISC-V processor or ARM processor. In other embodiments, different and/or additional general purpose processor(s) may be used. The GP processor 110 provides control instructions and data to the compute engines 120. GP processor 110 implements instruction set(s) used in controlling compute engines 120. GP processor 110 provides the commands to compute engines 120 and controls data movement to and/or from compute engines 120. GP processor 110 may thus function as part of a control plane for (i.e. providing commands and being part of the data path) compute engines 120 and tile 100.

In some embodiments, data is moved from memory 130 or another source to compute engine(s) 120 through GP processor 110. Data may be sent from memory 130 to internal memory of GP processor 110, and then to the appropriate compute engine(s) 120 via buses 140 and 150. For example, data from memory 130 may be provided to a vector register file (not shown) of GP processor 110 and then provided from GP processor 110 to the appropriate compute engine(s) 120. Once compute engines 120 have performed their functions, the output is provided to GP processor 110. Similarly, data may be moved from compute engines 120 to memory 130 or another destination via GP processor 110. Thus, GP processor 110 may be part of both the control plane and data plane for compute tile 100.

GP processor 110 may also perform other functions. GP processor 110 may apply activation function(s) to data. For example, an activation function (e.g. a ReLu, Tanh, and/or SoftMax) may be applied to the output of compute engine(s) 120. Thus, GP processor 110 may perform nonlinear operations. GP processor 110 may also perform linear functions and/or other operations. However, GP processor 110 is still desired to have reduced functionality as compared to, for example, a graphics processing unit (GPU) or central processing unit (CPU) of a computer system with which tile 100 might be used.

Compute engines 120 are configured to perform, efficiently and in parallel, tasks that may be part of using (e.g. performing inferences) and/or training (e.g. performing inferences and/or updating weights) a model. Compute engines 120 are coupled with and receive commands and, in at least some embodiments, data from GP processor 110. Compute engines 120 are modules which perform vector-matrix multiplications (VMMs) in parallel. Thus, compute engines 120 may perform linear operations. Each compute engine 120 includes a compute-in-memory (CIM) hardware module (not specifically shown in FIG. 1). The CIM hardware module stores weights corresponding to a matrix and is configured to perform a VMM in parallel for the matrix. Compute engines 120 may also include local update (LU) module(s) (not specifically shown in FIG. 1). Such LU module(s) allow compute engines 120 to update weights stored in the CIM.

The CIM module is a hardware module that stores data and performs operations. In some embodiments, CIM module stores weights for the model. As such, the CIM module determines the maximum size of the model that can be handled by compute tile 100 (i.e. the maximum number of parameters, or weights). The CIM module stores the weights (or other data) in cells that are fully addressable. The CIM module also performs operations using the weights. More specifically, the CIM module performs VMMs, where the vector may be an input vector (e.g. an activation) provided using GP processor 110 and the matrix may be weights (i.e. data/parameters) stored by the CIM module. The CIM module may be considered to include a memory (e.g. that stores the weights) and compute hardware (e.g. that performs the vector-matrix multiplication of the stored weights). In some embodiments, the vector may be a matrix. The CIM module may include an analog SRAM having multiple SRAM cells and configured to provide output(s) (e.g. voltage(s)) corresponding to the data (weight/parameter) stored in each cell of the SRAM multiplied by a corresponding element of the input vector. In some embodiments, the CIM module may include a digital SRAM having multiple SRAM cells and configured to provide output(s) corresponding to the data (weight/parameter) stored in each cell of the digital SRAM multiplied by a corresponding element of the input vector. Other configurations of CIM modules are possible. Each CIM module thus stores weights corresponding to a matrix in its cells and is configured to perform a vector-matrix multiplication of the matrix with an input vector. In some embodiments, the CIM module of a compute engine 120 may be repurposed as memory if the compute engine utilization falls below a particular threshold (e.g. 70%-80%). For example, the CIM might store duplicate weights or vectors (e.g. activations) in such embodiments.

In order to facilitate on-chip learning, local update (LU) modules (not shown) may also be provided in compute engines 120. LU modules are coupled with the corresponding CIM modules. LU modules are used to update the weights (or other data) stored in the CIM modules. LU modules are considered local because LU modules are in proximity to CIM modules. For example, LU module(s) for a particular compute engine 120 may reside in the same integrated circuit as the CIM module(s) for compute engine 120. In some embodiments, the LU module is considered local because it is fabricated on the same substrate (e.g. the same silicon wafer) as the corresponding CIM module. In some embodiments, LU modules are also used in determining the weight updates. In other embodiments, a separate component may calculate the weight updates. For example, in addition to or in lieu of LU modules, the weight updates may be determined by GP processor 110, in software by other processor(s) not part of compute tile 100, by other hardware that is part of compute tile 100, by other hardware outside of compute tile 100, and/or some combination thereof.

Memory 130 may be or include a static random access memory (SRAM) and/or some other type of memory. Memory 130 is shown as coupled with GP processor 110. Stated differently, data movement between memory 130 and compute engines 120 may take place via GP processor 120. In some embodiments, memory 130 may be coupled to compute bus 140 (i.e. to compute engines 120). Memory 130 may store activations (e.g. input vectors provided to compute tile 100 and the resultant of activation functions applied to the output of compute engines 120). Memory 130 may also store weights. For example, memory 130 may contain a backup copy of the weights or different weights if the weights stored in compute engines 120 are desired to be changed. In some embodiments, memory 130 is organized into banks of cells (e.g. banks of SRAM cells). In such embodiments, specific banks of memory 130 may service specific one(s) of compute engines 120. In other embodiments, banks of memory 130 may service any compute engine 120.

In operation, an input vector is provided to one or more of compute engines 120 by GP processor 110. The input vector is desired to be multiplied by the weights, which may have been previously stored in compute engine(s) 120. An input vector may be provided to multiple compute engines 120 if the weight matrix and/or input vector have too many elements for a single compute engine. In some such embodiments, a portion of the input vector is provided to each of the multiple compute engines 120 (each of which stores a portion of the weights). In some embodiments, the input vector is provided from memory 130 to GP processor 110 and from GP processor 110 to compute engine(s) 120. GP processor 110 also instructs compute engine(s) 120 to perform a VMM. Compute engine(s) 120 perform a VMM between the input vector and the matrix of weights to provide an output. The VMM is performed in parallel for the elements of the input vector. The output of compute engine(s) 120 may be considered an output vector. The output is provided by compute engine(s) 120 to GP processor 110. For example, the output may be stored in a vector register file of GP processor 110. GP processor 110 may also store the output (e.g. in memory 130) and/or may provide the output to another component off-tile. GP processor 110 may apply a function (e.g. an activation function) to the output. The results of the activation function applied to the output of compute engines 120 may be stored in GP processor 110 (e.g. in a buffer or the vector register file). GP processor 110 may also store the results in memory 130 or off-tile. GP processor 110 may provide the results as an input vector to other compute engine(s) 120 to apply a different set of weights to the results where another set of weights are stored in other compute engine(s) 120. Thus, one or more inferences with one or more distinct sets of weights may be performed. In some embodiments, training may also be performed by tile 100. In some such embodiments, GP processor 110 or another component (such as a host) may determine the desired update for the weights. In some embodiments, LU module (not shown) of compute engines 120 may be used to determine and apply the updates to the weights.

Thus, compute tile 100 includes two compute blocks, GP processor 110 and compute engines 120, which work together. GP processor 110 may perform nonlinear operations (e.g. activation functions) and compute engines perform 120 may perform linear operations (e.g. VMMs). GP processor 110 is in the control and data planes for compute engines 120. GP processor 110 and compute engines 120 are, therefore, tightly coupled. Consequently, data may be moved more efficiently within tile 100. Operations, such as VMMs and the application of activation functions to the output of compute engines 120, may be more efficiently performed. Further, a special purpose controller need not be designed and fabricated for compute tile 100. Instead, GP processor 110 is used. As a result, compute tile 100 may be more flexible and more readily designed and fabricated. For example, the activation applied by GP processor 110 may be updated by updating GP processor 110. A new special purpose controller need not be provided. Consequently, functions for machine learning may be more efficiently and readily performed. In addition, compute tile 100 includes on-tile memory 130. Use of on-tile memory, for example as a scratchpad memory, allows for a high degree of independence of compute tile 100 from other components (e.g. other tiles). Thus, multiple tiles 100 may more readily work in parallel. Consequently, efficiency of learning may be enhanced.

FIG. 2 is a diagram depicting an embodiment of compute tile 200 usable in a learning network. Compute tile 200 that may be an AI accelerator having an efficient architecture. Compute tile 200 is analogous to compute tile 100. Compute tile 200 thus includes GP processor 210 and compute engines 220-0 through 220-5 (collectively or generically compute engines 220) analogous to GP processor 110 and compute engines 110-0 through 110-5, respectively. Although six compute engines 210 are shown, in other embodiments another number may be included. GP processor 210 is shown as being coupled with compute engines 220 via compute bus (or other connector) 240, and bus 250. In other embodiments, GP processor 210 may be connected with compute engines 220 in another manner. Compute tile 200 may include on-tile memory 230 that is analogous to on-tile memory 130. Memory 230 may thus be or include SRAM. Data movement between memory 230 and compute engines 220 may take place via GP processor 220. In some embodiments, memory 230 may be coupled to compute bus 240 (i.e. to compute engines 220). In the embodiment shown, compute tile 200 also includes bus 260, direct memory access (DMA) module 270, and mesh stop 280.

GP processor 210 is analogous to GP processor 110. Thus, GP processor 210 may be a RISC-V processor or ARM processor. In other embodiments, different and/or additional general purpose processor(s) may be used. The GP processor 210 provides control instructions and manages data flow for the compute engines 220. Data sent to or from compute engines 220 may also pass through GP processor 210. Thus, GP processor 210 may be part of both the control plane and data plane for compute tile 200. GP processor 210 may also perform other functions, including nonlinear functions. For example, GP processor 210 may apply activation function(s) to data. In some embodiments, GP processor 210 may include a vector processing unit (not shown) that executes nonlinear operations (e.g. applying activation functions to data). Also explicitly shown as part of GP processor 210 are local memories 212 and 214. In some embodiments, local memory 212 stores instructions while local memory 214 stores data.

Compute engines 220 are analogous to compute engines 120. Compute engines 220 are configured to perform, efficiently and in parallel, tasks that may be part of using and/or training a model. Compute engines 220 are coupled with and receive commands and, in at least some embodiments, data from GP processor 210. Compute engines 220 perform linear operations such as VMMs in parallel. Each compute engine 220 includes a CIM hardware module (not specifically shown in FIG. 2) analogous to that described for compute engines 120. The CIM hardware module stores weights corresponding to a matrix and is configured to perform a VMM for the matrix. Compute engines 220 may also include LU module(s) (not specifically shown in FIG. 2).

Bus 250 couples GP processor 210 with compute bus 240 and, therefore, with compute engines 220. Compute bus 250 includes control bus 252, streaming bus 254, and status bus 256. Control bus 252, streaming bus 254, and status bus 256 are coupled with a command port (not explicitly labeled), a streaming port (not explicitly labeled), and a status port (not explicitly labeled), respectively, of GP processor 210. Control bus 252 receives instructions for compute engines 220 from GP processor 210. Compute engines 220 perform operations based on the instructions. For example, the instructions may include a load instruction to load data from GP processor 210 to identified compute engine(s) 220, a store instruction to store data from identified compute engine(s) 220 to GP processor 210, and supporting instructions that identify the addresses in identified compute engine(s) 220 to which data is to be loaded and from which data is to be read. Streaming bus 254 may be a high speed, high bandwidth bus. In some embodiments, streaming bus 254 is 512 bits wide. Other bus widths are possible. Streaming bus 254 is used to rapidly move data between GP processor 210 and compute engines 220. Status bus may allow for reading from or writing to a status register for a compute engine 220. Thus, GP processor 210 may be informed of the particular compute engine 220 completing a task, such as a VMM.

Compute tile 200 also includes DMA 270 and mesh stop 280. DMA 270 initiates data movement for compute tile 200. DMA 270 may be used to move data from off-tile to on-tile and vice-versa. Thus, DMA 270 may be used to communicate with a host (not shown) and/or other tiles (not shown in FIG. 2). For example, DMA 270 may be used to move input vectors (activations) from the host or another tile (not shown in FIG. 2) to memory 230. If memory 230 is also directly connected to compute engines 220 (e.g. via compute bus 240), then DMA 270 may be used to move data between memory 230 and compute engines 220. Mesh stop 280 provides an interface between compute tile 200 and the fabric of a mesh network that includes compute tile 200. Thus, mesh stop 280 may be used to communicate with other compute tiles (not shown) with which compute tile 200 may be used. Data may also be moved via bus 260. In some embodiments, therefore, data may be moved to and/or from memory 230 as well as to and/or from tile 200 via buses such as bus 240, 250, and/or 260.

Compute tile 200 functions in an analogous manner to compute tile 100. For example, data may be transferred on-tile from a host or other tile via DMA 270 and/or mesh stop 280. Such data may be stored in memory 230. Thus, memory 230 may store weights and input vectors. The weights may be loaded in one or more compute engines 220 for use. For example, the weights may be moved from memory 230 to the CIM hardware module(s) of compute engine(s) 220 via GP processor 210. For an inference, an input vector is provided to one or more of compute engines 220 by GP processor 210. To do so, the input vector/activation may be moved from memory 230 to GP processor 210 and from GP processor 210 to compute engine(s) 220 via streaming bus 254. Compute engine(s) 220 perform a VMM in parallel of the elements of the input vector and the matrix (or matrices) of weights stored in compute engine(s) 220. The output of compute engine(s) 220 may be stored from compute engine(s) 220 to GP processor 210 via streaming bus 254. GP processor 210 may apply a function (e.g. an activation function) to the output. The resultant of the activation function applied to the output of compute engines 220 may be stored in GP processor 210 (e.g. a buffer, which is not explicitly shown in FIG. 2). GP processor 210 may also store the resultant in memory 230. GP processor 210 may provide the resultant to another tile or the host via mesh stop 280 or DMA 270. GP processor may provide the resultant as an input vector to other compute engine(s) 220 to apply a different set of weights to the resultant where another set of weights are stored in other compute engine(s). Thus, one or more inferences with one or more distinct sets of weights may be performed. In some embodiments, training may also be performed by tile 200. In some such embodiments, GP processor 210 or another component (such as a host) may determine the desired update for the weights. In some embodiments, LU module (not shown) of compute engines 220 may be used to determine and apply the updates to the weights.

Compute tile 200 may share the benefits of compute tile 100. GP processor 210 and compute engines 220 are compute blocks which work closely together. For example, the data and control planes for compute tile 200 may include memory 230, GP processor 210, buses 240 and 250, and compute engines 220. Consequently, data may be moved more efficiently within tile 200 and operations, such as VMMs and the application of activation functions, may be more efficiently performed. Further, a special purpose controller need not be designed and fabricated for compute tile 200. As a result, compute tile 200 may be more flexible and more readily designed and fabricated. Consequently, functions for machine learning may be more efficiently and readily performed. In addition, on-tile memory 230 allows for a high degree of independence of compute tile 200 from other components (e.g. other tiles). Thus, multiple tiles 200 may more readily work in parallel and efficiency may be improved.

FIG. 3 is a diagram depicting an embodiment of compute tile 300 usable in a learning network. Compute tile 300 that may be an AI accelerator having an efficient architecture. Compute tile 300 is analogous to compute tiles 100 and 200. Compute tile 300 thus includes GP processor 310, compute engines 320-0 through 320-5 (collectively or generically compute engines 320), memory 330, compute bus 340, bus 350, bus 360, DMA 370, and mesh stop 380 that are analogous to GP processors 110/210, compute engines 120/220, memory 130/230, compute bus 140/240, bus 150/250, bus 260, DMA 270, and mesh stop 280, respectively. Although six compute engines 320 are shown, in other embodiments another number may be included. GP processor 310 is shown as being coupled with compute engines 320 via compute bus (or other connector) 340, and bus 350. In other embodiments, GP processor 310 may be connected with compute engines 320 in another manner. GP processor 310 also includes memories 312 and 314 analogous to local memories 212 and 214, respectively. Data movement between memory 330 and compute engines 320 may take place via GP processor 320. For example, bus 350 includes control bus 352, streaming bus 354, and status bus 356 analogous to control bus 252, streaming bus 254, and status bus 256, respectively. In some embodiments, memory 330 may be coupled to compute bus 340 (i.e. to compute engines 320).

GP processor 310 is analogous to GP processors 110 and/or 210. Thus, GP processor 310 may be a RISC-V processor or ARM processor. In other embodiments, different and/or additional general purpose processor(s) may be used. The GP processor 310 provides control instructions and manages dataflow for the compute engines 320. Data sent to or from compute engines 320 may also pass through GP processor 310. Thus, GP processor 310 may be part of both the control plane and data plane for compute tile 300. GP processor 310 may also perform other functions, including nonlinear functions. For example, GP processor 310 may apply activation function(s) to data. In some embodiments, GP processor 310 may include a vector processing unit (not shown) that executes nonlinear operations (e.g. applying activation functions to data).

In addition, GP processor includes an additional fixed function compute block (FFCB) 316. In some embodiments, FFCB 316 is a single instruction multiple data arithmetic logic unit (SIMD ALU). In some embodiments, FFCB 316 may be configured in another manner. FFCB 316 may be a close-coupled fixed-function unit for on-device inference and training of learning networks. In some embodiments, FFCB 316 executes nonlinear operations, number format conversion and/or dynamic scaling. In some embodiments, other and/or additional operations may be performed by FFCB 316. FFCB 316 may be coupled with the data path for the vector processing unit of GP processor 310.

Compute engines 320 are analogous to compute engines 120 and/or 220. Compute engines 320 are configured to perform, efficiently and in parallel, tasks that may be part of using and/or training a model. Compute engines 320 are coupled with and receive commands and, in at least some embodiments, data from GP processor 310. Compute engines 320 perform linear operations such as VMMs in parallel. Each compute engine 320 includes a CIM hardware module (not specifically shown in FIG. 3) analogous to that described for compute engines 120. The CIM hardware module stores weights corresponding to a matrix and is configured to perform a VMM for the matrix. Compute engines 320 may also include LU module(s) (not specifically shown in FIG. 3). In addition, on-tile memory 330 allows for a high degree of independence of compute tile 300 from other components (e.g. other tiles). Thus, multiple tiles 300 may more readily work in parallel.

GP processor 310 is also depicted as including vector processing unit (VPU) 318. In some embodiments, VPU 318 includes vector registers (VRs). In some embodiments, one vector register file, which includes thirty-two VRs, may be included. Each VR may store thirty-two sixteen-bit pieces of data (e.g. each register may store five hundred and twelve bits of data). In some embodiments, therefore, each vector register includes thirty-two entries, and each entry may store sixteen bits of data. In other embodiments, VPU 318 may be configured differently. In some embodiments, memory 314 may be considered VRs for corresponding VPU(s). Further, in some embodiments, GP processor 310 may include other components. For example, a high bandwidth memory and/or other components may be present.

FIG. 4 depicts compute engine 400 usable in an AI accelerator. Compute engine 400 may be part of an AI accelerator that can be deployed for using a model (not explicitly depicted) and for allowing for on-chip training of the model (otherwise known as on-chip learning). Compute engine 400 may thus be used as compute engine(s) 120, 220, and/or 320. Compute engine 400 includes CIM module 430 and LU module 440. Although one CIM module 430 and one LU module 440 is shown, a compute engine may include another number of CIM modules 430 and/or another number of LU modules 440. For example, a compute engine might include three CIM modules 430 and one LU module 440, one CIM module 430 and two LU modules 440, or two CIM modules 430 and two LU modules 440.

CIM module 430 is a hardware module that stores data and performs operations. In some embodiments, CIM module 430 stores weights for the model. CIM module 430 also performs operations using the weights. More specifically, CIM module 430 performs vector-matrix multiplications, where the vector may be an input vector provided using processor 110 and the matrix may be weights (i.e. data/parameters) stored by CIM module 430. Thus, CIM module 430 may be considered to include a memory (e.g. that stores the weights) and compute hardware (e.g. that performs the vector-matrix multiplication of the stored weights). In some embodiments, the vector may be a matrix (i.e. an n×m vector where n>1 and m>1). For example, CIM module 430 may include an analog static random access memory (SRAM) having multiple SRAM cells and configured to provide output(s) (e.g. voltage(s)) corresponding to the data (weight/parameter) stored in each cell of the SRAM multiplied by a corresponding element of the input vector. In some embodiments CIM module 430 may include a digital static SRAM having multiple SRAM cells and configured to provide output(s) corresponding to the data (weight/parameter) stored in each cell of the digital SRAM multiplied by a corresponding element of the input vector. In some embodiments, CIM module 430 may include an analog resistive random access memory (RAM) configured to provide output (e.g. voltage(s)) corresponding to the impedance of each cell multiplied by the corresponding element of the input vector. Other configurations of CIM module 530 are possible. Each CIM module 430 thus stores weights corresponding to a matrix in its cells and is configured to perform a vector-matrix multiplication of the matrix with an input vector.

In order to facilitate on-chip learning, LU module 440 may be provided. LU module 440 is coupled with the corresponding CIM module 430. LU module 440 is used to update the weights (or other data) stored in CIM module 430. LU module 440 is considered local because LU module 440 is in proximity with CIM module 430. For example, LU module 440 may reside on the same integrated circuit as CIM module 430. In some embodiments LU module 440 for a particular compute engine resides in the same integrated circuit as the CIM module 430. In some embodiments, LU module 440 is considered local because it is fabricated on the same substrate (e.g. the same silicon wafer) as the corresponding CIM module 430. In some embodiments, LU module 440 is also used in determining the weight updates. In other embodiments, a separate component may calculate the weight updates. For example, in addition to or in lieu of LU module 440, the weight updates may be determined by a GP processor, in software by other processor(s) not part of compute engine 400 and/or the corresponding AI accelerator (e.g. compute tile 100, 200, or 300), by other hardware that is part of compute engine 400 and/or the corresponding AI accelerator (e.g. compute tile 100, 200, or 300), by other hardware outside of compute engine 400 or the corresponding AI accelerator (e.g. compute tile 100, 200, or 300), and/or some combination thereof.

Using compute engine 400 in the context of compute tiles 100, 200, or 300 and/or an analogous system, efficiency and performance of a learning network may be improved. Use of CIM modules 430 may dramatically reduce the time to perform the vector-matrix multiplication that provides the weighted signal. Thus, performing inference(s) using compute engine 400 may require less time and power. This may improve efficiency of training and use of the model. LU modules 440 allow for local updates to the weights in CIM modules 430. This may reduce the data movement that may otherwise be required for weight updates. Consequently, the time taken for training may be greatly reduced. In some embodiments, the time taken for a weight update using LU modules 440 may be an order of magnitude less (i.e. require one-tenth the time) than if updates are not performed locally. Efficiency and performance of a learning network provided using system 100 may be increased.

FIG. 5 depicts an embodiment of compute engine 500 usable in an AI accelerator and capable of performing local updates. Compute engine 500 may be a hardware compute engine analogous to compute engine 400. Compute engine 500 thus includes CIM module 530 and LU module 540 analogous to CIM modules 430 and LU modules 440, respectively. Compute engine 500 also includes analog bit mixer (aBit mixer) 504-1 through 504-n (generically or collectively 504), analog to digital converter(s) (ADC(s)) 506-1 through 506-n (generically or collectively 506), input buffer 550, output buffer 560, and address decoder 570. Although particular numbers of components 502, 504, 506, 530, 540, 542, 544, 546, 360, and 570 are shown, another number of one or more components 502, 504, 506, 530, 540, 542, 544, 546, 360, and 570 may be present.

CIM module 530 is a hardware module that stores data corresponding to weights and performs vector-matrix multiplications. The vector is an input vector provided to CIM module 530 (e.g. via input buffer 550) and the matrix includes the weights stored by CIM module 530. In some embodiments, the vector may be a matrix. Examples of embodiments CIM modules that may be used in CIM module 530 are depicted in FIGS. 6 and 7.

FIG. 6 depicts an embodiment of a cell in one embodiment of an SRAM CIM module usable for CIM module 530. Also shown is DAC 502 of compute engine 500. For clarity, only one SRAM cell 610 is shown. However, multiple SRAM cells 610 may be present. For example, multiple SRAM cells 610 may be arranged in a rectangular array. An SRAM cell 610 may store a weight or a part of the weight. The CIM module shown includes lines 602, 604, and 618, transistors 606, 608, 612, 614, and 616, capacitors 620 (C_{S}) and 622 (C_{L}). In the embodiment shown in FIG. 6, DAC 502 converts a digital input voltage to differential voltages, V₁ and V₂, with zero reference. These voltages are coupled to each cell within the row. DAC 502 is thus used to temporal code differentially. Lines 602 and 604 carry voltages V₁ and V₂, respectively, from DAC 502. Line 618 is coupled with address decoder 570 (not shown in FIG. 6) and used to select cell 610 (and, in the embodiment shown, the entire row including cell 610), via transistors 606 and 608.

In operation, voltages of capacitors 620 and 622 are set to zero, for example via Reset provided to transistor 616. DAC 502 provides the differential voltages on lines 602 and 604, and the address decoder (not shown in FIG. 6) selects the row of cell 610 via line 618. Transistor 612 passes input voltage V₁ if SRAM cell 610 stores a logical 1, while transistor 614 passes input voltage V₂ if SRAM cell 610 stores a zero. Consequently, capacitor 620 is provided with the appropriate voltage based on the contents of SRAM cell 610. Capacitor 620 is in series with capacitor 622. Thus, capacitors 620 and 622 act as capacitive voltage divider. Each row in the column of SRAM cell 610 contributes to the total voltage corresponding to the voltage passed, the capacitance, C_{S}, of capacitor 620, and the capacitance, C_{L}, of capacitor 622. Each row contributes a corresponding voltage to the capacitor 622. The output voltage is measured across capacitor 622. In some embodiments, this voltage is passed to the corresponding aBit mixer 504 for the column. In some embodiments, capacitors 620 and 622 may be replaced by transistors to act as resistors, creating a resistive voltage divider instead of the capacitive voltage divider. Thus, using the configuration depicted in FIG. 6, CIM module 530 may perform a vector-matrix multiplication using data stored in SRAM cells 610.

FIG. 7 depicts an embodiment of a cell in one embodiment of a digital SRAM module usable for CIM module 530. For clarity, only one digital SRAM cell 710 is labeled. However, multiple cells 710 are present and may be arranged in a rectangular array. Also labeled are corresponding transistors 706 and 708 for each cell, line 718, logic gates 720, adder tree 722 and digital mixer 724. Because the SRAM module shown in FIG. 7 is digital, DACs 502, aBit mixers 504, and ADCs 506 may be omitted from compute engine 500 depicted in FIG. 5.

In operation, a row including digital SRAM cell 710 is enabled by address decoder 570 (not shown in FIG. 7) using line 718. Transistors 706 and 708 are enabled, allowing the data stored in digital SRAM cell 710 to be provided to logic gates 720. Logic gates 720 combine the data stored in digital SRAM cell 710 with the input vector. Thus, the binary weights stored in digital SRAM cells 710 are combined with the binary inputs. The output of logic gates 720 are accumulated in adder tree 722 and combined by digital mixer 724. Thus, using the configuration depicted in FIG. 7, CIM module 530 may perform a vector-matrix multiplication using data stored in digital SRAM cells 710.

Referring back to FIG. 5, CIM module 530 thus stores weights corresponding to a matrix in its cells and is configured to perform a vector-matrix multiplication of the matrix with an input vector. In some embodiments, compute engine 500 stores positive weights in CIM module 530. However, the use of both positive and negative weights may be desired for some models and/or some applications. In such cases, bipolar weights (e.g. having range −S through +S) are mapped to a positive range (e.g. 0 through S). For example, a matrix of bipolar weights, W, may be mapped to a positive weight matrix Wₚ such that: Wx=(Wₚ−SJ/2)(2x)=5Wₚx−SΣᵢxᵢ. where J is a matrix of all ones having the same size as W and S is the maximum value of the weight (e.g. 2^{N-1}−1 for an N-bit weight). For simplicity, compute engine 500 is generally discussed in the context of CIM module 530 being an analog SRAM CIM module analogous to that depicted in FIG. 6.

Input buffer 550 receives an input vector for which a vector-matrix multiplication is desired to be performed. In some embodiments, the input vector is provided to input buffer by a GP processor, such as GP processor 110. The input vector may be read from a memory, from a cache or register in the processor, or obtained in another manner. Digital-to-analog converter (DAC) 502 converts a digital input vector to analog in order for CIM module 530 to operate on the vector. Although shown as connected to only some portions of CIM module 530, DAC 502 may be connected to all of the cells of CIM module 530. Alternatively, multiple DACs 502 may be used to connect to all cells of CIM module 530. Address decoder 570 includes address circuitry configured to selectively couple vector adder 544 and write circuitry 542 with each cell of CIM module 530. Address decoder 570 selects the cells in CIM module 530. For example, address decoder 570 may select individual cells, rows, or columns to be updated, undergo a vector-matrix multiplication, or output the results. In some embodiments, aBit mixer 504 combines the results from CIM module 530. Use of aBit mixer 504 may save on ADCs 506 and allows access to analog output voltages.

ADC(s) 506 convert the analog resultant of the vector-matrix multiplication to digital form. Output buffer 560 receives the result of the vector-matrix multiplication and outputs the result from compute engine 500. Thus, a vector-matrix multiplication may be performed using CIM module 530.

LU module 540 includes write circuitry 542 and vector adder 544. In some embodiments, LU module 540 includes weight update calculator 546. In other embodiments, weight update calculator 546 may be a separate component and/or may not reside within compute engine 500. Weigh update calculator 546 is used to determine how to update to the weights stored in CIM module 530. In some embodiments, the updates are determined sequentially based upon target outputs for the learning system of which compute engine 500 is a part. In some embodiments, the weight update provided may be sign-based (e.g. increments for a positive sign in the gradient of the loss function and decrements for a negative sign in the gradient of the loss function). In some embodiments, the weight update may be ternary (e.g. increments for a positive sign in the gradient of the loss function, decrements for a negative sign in the gradient of the loss function, and leaves the weight unchanged for a zero gradient of the loss function). Other types of weight updates may be possible. In some embodiments, weight update calculator 546 provides an update signal indicating how each weight is to be updated. The weight stored in a cell of CIM module 530 is sensed and is increased, decreased, or left unchanged based on the update signal. In particular, the weight update may be provided to vector adder 544, which also reads the weight of a cell in CIM module 530. More specifically, adder 544 is configured to be selectively coupled with each cell of CIM module by address decoder 570. Vector adder 544 receives a weight update and adds the weight update with a weight for each cell. Thus, the sum of the weight update and the weight is determined. The resulting sum (i.e. the updated weight) is provided to write circuitry 542. Write circuitry 542 is coupled with vector adder 544 and the cells of CIM module 530. Write circuitry 542 writes the sum of the weight and the weight update to each cell. In some embodiments, LU module 540 further includes a local batched weight update calculator (not shown in FIG. 5) coupled with vector adder 544. Such a batched weight update calculator is configured to determine the weight update.

Compute engine 500 may also include control unit 540. Control unit 540 generates the control signals depending on the operation mode of compute engine 500. Control unit 540 is configured to provide control signals to CIM hardware module 530 and LU module 549. Some of the control signals correspond to an inference mode. Some of the control signals correspond to a training, or weight update mode. In some embodiments, the mode is controlled by a control processor (not shown in FIG. 5, but analogous to processor 110) that generates control signals based on the Instruction Set Architecture (ISA).

In inference mode, the input data is multiplied by the stored weights and output is obtained after ADC 506. This mode may include many steps. For example, if capacitors arranged in a voltage divider are used to provide the output (e.g. in FIG. 6), the capacitors (or other storage elements) may be reset. For example, capacitors are rest to either zero or certain precharge value depending on the functionality of the capacitor. Capacitive voltage divider operation is enabled to provide the output of the vector-matrix-multiplication. aBit mixer 504 is enabled. ADC(s) 506 are also enabled. Data are stored in output buffer 560 to be passed to the compute engine or other desired location(s). This process may be repeated for the entire vector multiplication. In weight update mode, the weight update signals may be generated sequentially by weight update calculator 546. In parallel, cells in a row of CIM module 530 are read row by row and passed to adder 544 for the corresponding weight update.

Using compute engine 500, efficiency and performance of a learning network may be improved. CIM module 530 may dramatically reduce the time to perform the vector-matrix multiplication. Thus, performing inference(s) using compute engine 500 may require less time and power. This may improve efficiency of training and use of the model. LU module 540 uses components 542, 544, and 546 to perform local updates to the weights stored in the cells of CIM module 530. This may reduce the data movement that may otherwise be required for weight updates. Consequently, the time taken for training may be dramatically reduced. Efficiency and performance of a learning network provided using compute engine 500 may be increased.

For example, FIG. 8 depicts an embodiment of data flow in learning network 800 that can be implemented using compute tile 100, 200, and/or 300 and/or compute engine(s) 400 and/or 500. Learning network 800 includes weight layers 810-1 and 810-2 (collectively or generically 810) and activation layers 820-1 and 820-2 (collectively or generically 820). For training, loss function calculator 830 as well as weight update block 840 are shown. Weight update block 840 might utilize techniques including but not limited to back propagation, equilibrium propagation, feedback alignment and/or some other technique (or combination thereof). In operation, an input vector is provided to weight layer 810-1. A first weighted output is provided from weight layer 810-1 to activation layer 820-1. Activation layer 820-1 applies a first activation function to the first weighted output and provides a first activated output to weight layer 820-2. A second weighted output is provided from weight layer 810-2 to activation layer 820-2. Activation layer 820-2 applies a second activation function to the second weighted output. The output is provided to loss calculator 830. Using weight update technique(s) 840, the weights in weight layer(s) 810 are updated. This continues until the desired accuracy is achieved.

Compute tile(s) 100, 200, and/or 300 and compute engine(s) 120, 220, 320, 400, and/or 500 may be used to accelerate the processes of learning network 800. For simplicity, it is assumed that compute engine 500 is used in compute tile 300. Further, weight layers 810 are assumed to be storable within a single CIM module 530. Nothing prevents weight layers 810 from being extended across multiple CIM modules 530. In the data flow described above for learning network 800, an input vector is provided to a compute engine 320-1 from GP processor 310. More specifically, the input vector is provided to CIM module 530 (e.g. via input buffer 550 and DAC(s) 502). Initial values of weights are stored in, for example, SRAM cells (e.g. 610 or 710) of CIM module 530. A vector matrix multiplication is performed by CIM module 530 and provided to output buffer 560 (e.g. also using aBit mixers 504 and ADC(s) 506). Thus, the processes of weight layer 810-1 may be performed. Activation layer 820-1 may be performed using a GP processor 310. The output of activation layer 820-1 (e.g. from GP processor 310) is provided to the next weight layer 810-2. Initial weights for weight layer 810-2 may be in another compute engine 330-2/CIM module 530. In another embodiment, new weights corresponding to weight layer 810-2 may be stored in the same hardware CIM module 530 of the same compute engine 330-1. A vector matrix multiplication is performed by CIM module 530 and provided to output buffer 560 (e.g. also using aBit mixers 504 and ADC(s) 506). Activation layer 820-2 may be performed using a processor such as GP processor 310. The output of activation layer 820-2 is used to determine the loss function via hardware or GP processor 310. The loss function may be used to determine the weight updates by GP processor 310, weight update calculator 546/800. Using LU modules 540 and the weights in CIM modules 530, weight layers 810 may be updated. Thus, learning network 800 may be realized using compute tile 100, 200, and/or 300 and/or compute engine 500. The benefits thereof may, therefore, be obtained.

Compute engines 120, 220, 320, 400 and/or 500 may be combined in a variety of architectures. For example, FIGS. 9A-9C depict an embodiment of an architecture including multiple compute tiles 910, each of which is analogous to compute tile(s) 100, 200, and/or 300. An AI accelerator may include or be architecture 900. In some embodiments, architecture 900 may be considered a system on a chip (SoC) or a network on a chip (NoC). SoC 900 includes compute tiles 910, a DDR controller 920, PCIe or other analogous module 930, peripheral I/O module 940, management control processor (MCP) 950, and routers/mesh interconnects 970. Other and/or different components may be included. DDR controller 920 allows for DRAM (not shown) to be coupled with SoC 900. PCIe module 930 allows for connectivity to a host (not shown). Peripheral I/O module 940 may be merged with MCP 950 in some embodiments. MCP 950 may perform housekeeping and other management functions for SoC 900. Via routers/mesh interconnects 970 and modules such as mesh stops, such as mesh stops 280 and/or 380, tiles 910 may be interconnected.

In SoC 900, each tile 910 is an independent compute unit which has its own local memory analogous to SRAM 130, 230, and/or 330. Tiles 910 are interconnected by mesh interconnects. In some embodiments, this allows any tile 910 to access the memory of any other tile 910. Tiles 910 each have memory that is fully globally addressable. In some embodiments, a tile 910 may interact with any other tile 910 of SoC 900. Thus, tiles 920 may be considered to be tightly-coupled, independent compute and memory blocks with globally addressable memory that enable a compiler (not shown in FIGS. 9A-9C) to create custom super tiles. Super tiles can be formed by some combination of two or more tiles 910. For example, FIG. 9B depicts SoC 900 in which super tile 980 has been formed from eight tiles 910. Similarly, FIG. 9C depicts SoC 900 in which super tile 982 has been formed from seven tiles 910. Other supertiles may be formed. Super tiles may be used to create custom pipelines for scheduling computational graphs for execution using SoC 900 and/or for other purposes. In some embodiments, for example, an arbitrary computational graph can be mapped to SoC 900 via super tiles. The mesh interconnection of tiles 900 in SoC may reflects the custom traffic patterns observed on SoC 900. The custom traffic patterns might require support for multicast, broadcast for various operators (e.g. BatchNorm). In other embodiments, other and/or additional features may be supported based upon the traffic patterns.

Using SoC 900 efficiency and performance of a learning network may be improved. In addition to the benefits of the individual tiles 900, such as more efficient control and movement of data within a tile, SoC 900 may extend the benefits to larger systems. Through super tiles, SoC 900 may be tailored to the specific traffic patterns and applications with which SoC 900 is desired to be used. Consequently, efficiency and performance may be enhanced.

FIG. 10 is a flow chart depicting one embodiment of method 1000 for using a compute engine usable in an AI accelerator for training. Method 1000 is described in the context of compute tile 300 and compute engine 500. However, method 1000 is usable with other compute tiles, such as compute tiles 200 and/or 300 and/or other compute engines, such as engine 400. Although particular processes are shown in an order, the processes may be performed in another order, including in parallel. Further, processes may have substeps.

Weights corresponding to a weight matrix may be stored in one or more compute engines of a compute tile, at 1002. In some embodiments, this occurs at a time that is distinct from the remainder of method 1000. In some embodiments, 1002 includes storing the weights in the CIM hardware module of the compute engine of the compute tile. An input vector is provided to the compute engine(s) of the compute tile, at 1004. In some embodiments, this is performed via the GP processor corresponding to the compute tile. The compute engine(s) perform a VMM between the input vector and the matrix, at 1006. In some embodiments, this is performed by the CIM hardware module. Thus, 1006 provides an output that is the weight matrix multiplied by the input vector. One or more activation functions are applied to the output, at 1008. In some embodiments, 1008 is performed by the GP processor for the compute tile. At 1010, 1004, 1006, and 1008 may be repeated for multiple inferences with the same or other compute engines (e.g. other weight matrices).

For example, weights may be stored in the compute engines 320 of compute tile 300, at 1002. For example, data may be stored in SRAM cells 610 of CIM hardware modules 530 of compute engine 500. During inference or training, an input vector is provided to compute engine(s) 320. For example, an input vector stored in memory 330 may be provided to GP processor 310, and from GP processor 310 to the appropriate compute engine(s) 320. GP processor may instruct compute engine(s) 320 to perform a VMM of the input vector and the weight matrix stored in compute engine(s) 320. Thus, at 1006, compute engine(s) 320 perform VMM in parallel. For example, compute engine 500 may use CIM hardware module 530 to perform a VMM. Also at 1006, the output of the VMM is provided to GP processor 310. Activation function(s) are applied to the output, at 1008. This may be performed by GP processor 310. In some embodiments, fixed function computing block 316 may be used in accomplishing 1008. The resultant of the activation function being applied to the output of compute engines 320 may be stored by GP processor 310 in memory 130. At 1008, these processes may be repeated. Thus, inferences may be improved. Further, training may be performed on-chip using the resultants of method 1000 and, for example, LU modules 440 and/or 540.

Using method 1000, the benefits of compute tiles 100, 200, and/or 300 may be achieved. For example, efficiency and performance of learning may be improved. The time to perform the VMMs may be reduced and the movement of data made more efficient. This may improve efficiency of training and use of the model. Efficiency and performance of a learning network provided using method 1000 may be increased.

Compute engines 120, 220, and/or 320 may improve the efficiency of linear operations such as VMMs used in inference and training of a learning network. In order to better perform training, inferences, and/or other tasks, particular instructions may be utilized and/or nonlinear activation functions applied in an efficient manner. For simplicity, such instructions and functions are described in the context of compute tile 300 and compute engines 320 and 500. However, one of ordinary skill in the art will recognize that the methods, systems, and/or instructions described herein may be used in connection with other compute tiles including but not limited to compute tiles 100 and/or 200 and/or other compute engines including but not limited to 120, 220, and/or 400.

In some embodiments, GP processor 310 is configured to communicate with a single co-processor. Stated differently, GP processor 310 may be configured to communicate with a single compute engine 320. However, multiple compute engines 320 are present and desired to function with GP processor 310. To do so, custom instructions may be used for compute tile 300.

In some embodiments, a larger number of separate custom instructions might be utilized. For example, a first custom instruction may load activations (i.e. data/vectors to be multiplied with the matrix stored in storage cells of a compute engine) from memory 314 and/or a VR of VPU 318 to the input buffer (e.g. input buffer 550) of a particular compute engine 320. A second custom instruction may load data from an output buffer (e.g. output buffer 560) of a particular compute engine 320 to memory 314 and/or a VR of VPU 318. A third instruction may instruct compute engine 320 to perform a VMM. A fourth instruction may write weights from memory 314 and/or a VR of VPU 318 to the memory (e.g. CIM module 530) of compute engine 320. A fifth instruction may load weights from the memory (e.g. CIM module 530) of compute engine 320 to memory 314 and/or a VR of VPU 318. A sixth instruction may be used to update the weights where compute engine 320 can perform addition. The change in the weight is stored in the input buffer (e.g. input buffer 550) of compute engine 320. Control instructions such as a polling instruction to determine whether a compute engine is ready to receive an instruction (e.g. be written to or read/loaded from) and/or an arbitration instruction that arbitrates among the available compute engines 320 to determine which is used for the next operation. Although such instructions may be used for loading data to the appropriate compute engine 320 and reading data from the desired compute engine 320, further improvements may be achieved by configuring custom instructions for GP processor 310.

In some embodiments, three custom instructions may be used by the GP processor for data movement and two may be used for applying activation functions. To perform data movement, a first instruction may identify the compute engine to be used. This instruction may be used only once as long as the same compute engine is being written to and/or read form. For example, the first instruction might be used only once for a set of VMMs. The instruction identifying the compute engine may indicate the addresses recognized by the GP processor and which correspond to the compute engine being used. In some embodiments, the instruction writes a configuration to a compute engine address control register. The configuration identifies the compute engine (e.g. the addresses). In some embodiments, the configuration also describes the tasks (e.g. write to and/or read/load form) the compute engine is desired to perform. A second instruction writes data to the compute engine from the GP processor. For example, the instruction specifies the source of the data (e.g. the memory or register file including the data) as well as the destination (e.g. the address of the compute engine input buffer or storage cell(s) in the CIM module of the compute engine). The third instruction loads data from the compute engine to the GP processor. For example, the instruction specifies the source of the data (e.g. the address of the compute engine output buffer or storage cell(s) in the CIM module of the compute engine) as well as the destination (e.g. the memory or register file of the GP processor). Using the three instructions, data may be moved between the GP processor and the compute engines. In such embodiments, data may be moved to the GP processor from other sources (e.g. the memory on the compute tile or on another tile) using pre-existing instructions.

For example, FIG. 11 is a flow chart depicting an embodiment of method 1100 for utilizing three instructions to move data in a compute tile including compute engine(s) and a GP processor. For clarity, only some steps are shown and/or some steps may have substeps. Further, some steps may be performed in a different order, including in parallel. Method 1100 may start after data has been moved to the GP processor. In some cases, data may be moved to the GP processor between steps of method 1100. This may be accomplished using conventional or non-custom instructions. For example, data being written to a compute engine may be loaded from memory that is on the compute tile (such as SRAM), DRAM, and/or other memory. In some embodiments, therefore, the data resides in storage of the GP processor for method 1100. The flow of data described in method 1100 is for exemplary purposes only and is not intended to limit the use of the instructions. As indicated, method 1100 may be used in connection with a GP processor which is configured to communicate with a single co-processor or compute engine.

The GP processor executes an instruction identifying to the GP processor a first compute engine, at 1102. In some embodiments, the instruction is a custom instruction. The first compute engine identified at 1102 is one of a number of compute engines coupled with the GP processor. In some embodiments, the compute engines are on the same compute tile as the GP processor. The instruction may identify the compute engine by assigning particular addresses to the compute engine. For example, the addresses may include the input buffer of the first compute engine, the output buffer of the first compute engine, and/or storage cells (or an input buffer for the storage cells) in the CIM hardware module for the first compute engine. As a result, the GP processor is provided with information allowing the GP processor to write activations (i.e. input vectors) to, load the resultant in the output buffer from, and/or to write weights (or other data) to the storage cells of the CIM hardware module of the first compute engine.

The GP processor uses one or more instructions to move data between the GP processor and the first compute engine, at 1104. Other tasks may be performed by the GP processor between 1102 and 1104. In some embodiments, the GP processor may execute custom write and/or load instruction(s) at 1104. The GP processor may utilize addresses identified in 1102. For example, the first compute engine may be used to perform a VMM using a vector and weights stored in the CIM hardware module. The vector is stored in the GP processor. The GP processor writes data corresponding to the vector from the storage in the GP processor to the first compute engine at 1104. To do so, the GP processor may identify as the destination for the write instruction the address(es) for the input buffer of the first compute engine and may identify as the source for the custom write instruction the address(es) for the storage in the GP processor. In another example, the data to be written by the GP to the first compute engine may include weights. In this case, the GP processor may identify as the destination of the write instruction address(es) the storage cells of the CIM hardware module of the first compute engine or an input buffer for the storage cells of the CIM hardware module for the first compute engine. The GP processor may also identify the address(es) for the storage in the GP processor as the source for the write instruction. The GP processor may also read/load the first set of data from the first compute engine. To do so, the GP processor may identify as the source of a load instruction address(es) the output buffer of the CIM hardware module of the first compute engine. The GP processor may also identify the address(es) for the storage in the GP processor as the destination for the load instruction. At 1104, the GP processor may use one or more of these instructions to transfer data between the GP processor and the first compute engine. Stated differently, the GP processor may write weights (and/or write new weights) to, write vector(s) to, and/or load the output from the first compute engine at 1104.

During 1104, the GP processor might perform other tasks. For example, the GP processor might load other data from SRAM (or other storage). This other data may be written to the first compute engine as part of 1104 or may be written to another compute engine in a separate process. The GP processor might also write other data to SRAM (or other storage). For example, the output loaded from the first compute engine may be written to SRAM (or other storage). However, in some embodiments, the GP processor does not communicate with other compute engines. This is because the GP processor is configured to operate with a single co-processor (i.e. the first compute engine) and because only the first compute engine has been identified to the GP processor at 1102.

The GP processor executes an instruction identifying to the GP processor a second compute engine, at 1106. Other tasks may be performed by the GP processor between 1104 and 1106. The second compute engine is different from the first compute engine and is also one of a number of compute engines coupled with the GP processor. The instruction is the same used in 1102 but identifies the second compute engine instead of the first compute engine. The instruction may identify the second compute engine by assigning particular addresses to the second compute engine. The addresses may include the input buffer of the second compute engine, the output buffer of the second compute engine, and/or storage cells (or an input buffer for the storage cells) in the CIM hardware module for the second compute engine. As a result, the GP processor is provided with information allowing the GP processor to write activations to, load the resultant in the output buffer from, and/or to write weights (or other data) to the storage cells of the CIM hardware module of the second compute engine.

The GP processor uses one or more instructions to move data between the GP processor and the second compute engine, at 1108. Other tasks may be performed by the GP processor between 1106 and 1108. 1108 is analogous to 1104. However, addresses for the second compute engine are used in the destination or source of the data being moved instead of addresses for the first compute engine. Thus, the GP processor may perform other tasks during 1108. However, the GP processor may not communicate with compute engines other than the second compute engine.

The GP processor executes an instruction identifying to the GP processor the first compute engine, at 1110. Other tasks may be performed by the GP processor between 1108 and 1110. 1110 is analogous to 1102. The GP processor may again be able to communicate with the first compute engine. The GP processor may move data to or from the first compute engine, at 1112. 1112 may be analogous to 1104. Other tasks may be performed by the GP processor between 1110 and 1112.

Using method 1100, data may be moved to and from compute engines by a GP processor that is built to communicate with a single compute engine. In some instances, only a portion of method 1100 may be used for certain tasks. In some instances, one or more of 1102, 1104, 1106, 1108, 1110, and/or 1112 may be repeated for these or other compute engines. For example, referring to FIGS. 3, 5, and 11, compute engine 320-2 may be identified to GP processor 310, at 1102. The addresses of storage in compute engine 320-2 may be provided to GP processor 310 at 1102. At 1104, GP processor 310 may execute a write instruction to write a vector from internal storage (e.g. a VR in VPU 318 or other storage 314) to input buffer 550 of compute engine 320-2 (or 500) using these addresses. Before 1104, GP processor 310 has moved the data to internal storage 314/318. The source of this data may be off tile (e.g. via mesh stop 380) and/or SRAM 330. Because compute engine 320-2 has weights stored therein, compute engine 320-2 may perform a VMM in response to the vector being written to input buffer 550.

Compute engine 320-2 takes some time to complete the VMM. For example, in some embodiments, compute engine 320-2 might use eighty nanoseconds to complete the VMM. While compute engine 320-2 is operating, GP processor 310 is desired to continue perform tasks. Thus, at 1106, GP processor 310 may execute an instruction that identifies (i.e. provides the addresses for) compute engine 320-3. At 1108, GP processor 310 may execute the write instruction to write another vector from internal storage to input buffer 550 of compute engine 320-3 using these addresses. GP processor 310 may also repeat 1106 to identify compute engine 320-5. At a repeat of 1108, GP processor may also execute a write operation for a vector or weights or may load data from output buffer 560 of compute engine 320-5. GP processor 310 may then execute an instruction to re-identify compute engine 320-2, at 1110. This may occur because GP processor 310 has waited at least eighty nanoseconds, because GP processor 310 has polled compute engine 320-2 to determine whether compute engine 320-2 has completed its VMM, and/or for other reasons. At 1112, GP processor 310 may use the load instruction to load the results of the VMM from output buffer 560 of compute engine 320-2 to a register in VPU 318 and/or storage 314. In some cases, GP processor 310 may also write these results to other storage, such as SRAM 330.

Thus, using method 1100 and, in some embodiments, custom instruction(s), data may be efficiently moved between the GP processor and compute engines. Thus, GP processor is able to utilize the functions of multiple compute engines without being explicitly configured for the particular number of compute engines. Thus, less additional, specialized logic may be added to the GP processor. This may not only improve the efficiency of performance, but also reduce the area consumed by the GP processor. Performance may thus be improved.

A GP processor such as GP processor 110, 210, and/or 310, in a compute tile such as compute tile(s) 100, 200, and/or 300 is also used to apply nonlinear (e.g. activation) functions. For example, as part of inference, activation function(s) may be applied to the output of the VMMs performed by the compute engines. Examples of such activation functions include but are not limited to sigmoid, tanh, and ReLU. Although it is possible for the GP processor to mathematically compute, for each VMM output, the values of the activation function(s) to be applied, this may introduce latency. Consequently, in some embodiments, custom and/or specialized instructions may be used by the GP processor and a lookup table may be used. In some embodiments, the lookup table may be stored somewhere else on the compute tile (e.g. in SRAM) or off tile (e.g. in SRAM of another tile or in DRAM). However, this may still introduce latency. Thus, in some embodiments, the GP processor includes a lookup table. For example, a lookup table may be provided via fixed function computing block 316. In addition, in some embodiments, the lookup table may be stored in vector registers of a VPU (e.g. a register of VPU 318). In order to utilize the lookup table in applying activation function(s), custom instructions may be provided for the GP processor.

For example, FIG. 12 is a flow chart depicting one embodiment of method 1200 for using instructions to apply an activation function using a lookup table in an AI accelerator. Thus, method 1200 may be used as part of 1008 of method 1000. For clarity, only some steps are shown and/or some steps may have substeps. Further, some steps may be performed in a different order, including in parallel. Some or all of method 1200 may start after the output(s) of the VMM(s) from compute engine(s) have been moved to the GP processor. In some cases, the VMM output(s) may be moved to the GP processor between steps of method 1200. The flow of data described in method 1200 is for exemplary purposes only and is not intended to limit the use of the instructions for the lookup table. As indicated, method 1200 may be used in connection with a GP processor which is configured to communicate with a single co-processor or compute engine. Method 1200 is described in the context of compute tile 300 and compute engines 320 and 500. However, method 1200 may be used with other compute tiles and/or compute engines including but not limited to compute tiles 100 and 200 and compute engines 110, 210, and/or 400.

The lookup table is configured, at 1202. In some embodiments, 1202 utilizes a custom configuration instruction in order to configure the lookup table. For example, the custom instruction executed at 1202 may load the appropriate parameters into the lookup table. Also in 1202, the custom instruction may store parameters for the lookup table in a register. For example, in some embodiments, the lookup table may store values of the activation function for given values of the output of the VMM. However, such a lookup table may be extremely large. Consequently, in some embodiments, the lookup table may be a piecewise linear approximation lookup table. In such embodiments, the nonlinear activation functions are broken into sections. Each section is a line that may be described by:

$$Activation function ( x ) = ( m * x + c )$$

where: m=slope of the line
   c=y intercept for c
   x=value of the VMM
      In such embodiments, m and c may be stored in the lookup table and the addresses of m and c may be indexed by ranges in the value of x. At 1202, therefore, values m and c may be stored in the lookup table for various ranges and the ranges corresponding to the addresses of m and c stored in an additional register. In some embodiments, a scaling factor, such as a BF16 scaling factor used in quantization may also be part of the activation function. In some embodiments, additional parameters may be stored in the additional register. For example, a threshold for the activation function may be stored. For computed values above this threshold, a particular value (e.g. a predefined maximum value) may be returned instead. Thus, at 1202, the lookup table may be configured for use for a particular activation function. In some embodiments, the lookup table is configured such that the data for the lookup table may reside in a single vector register of a VPU (e.g. VPU 318). For example, a VPU may include a vector register file including thirty two vector registers, each of which includes thirty two sixteen-bit entries (e.g. a total of five hundred and twelve bits per register). In such an embodiment, the value of m may be eight bits in length (e.g. the first eight bits of the entry) and the value of c may be eight bits (e.g. the second eight bits of the entry). The lookup table may then include thirty-two segments for the activation function. In another embodiments, the value of m may be sixteen bits in length and occupy even entries, while the value of c may be sixteen bits long and occupy odd entries. In such embodiments the lookup table includes sixteen segments for the activation function. In some embodiments, 1202 may be performed only once for an inference, a data set, and/or other conditions.

At 1204, the resultant of the activation function being applied is determined based on the lookup table. For example, in some embodiments, the resultant may be looked up directly in the lookup table. Although this may be accurate and faster than calculating the resultant from the output of the VMM (i.e., x), it may also be an inefficient use of space and somewhat slow. In some embodiments, a piecewise linear lookup table is used. Thus, 1204 may include obtaining m and c from the lookup table and calculating the resultant based on m, c, and x (the value of the output of the VMM). In contrast to 1202, 1204 is generally performed many times.

For example, at 1202, GP processor 310 configures a lookup table. For example, lookup table may include lookup table logic 316 (i.e. fixed function computing block 316) as well as storage 314 and/or storage in VPU 318. Thus, the instruction executed by GP processor 310 may store parameters and data in storage 314, lookup table logic 316, and/or VPU 318. At 1204, GP processor 310 invokes the lookup table based to apply the activation function to the output of the VMM. The output of the VMM may be stored in vector registers of VPU 318 and/or storage 314. Thus, the activation function may be efficiently and rapidly applied to the output of the VMM while controlling the size of the lookup table.

In some embodiments, the lookup table may be provided using vector registers. FIG. 13 is a block diagram depicting one embodiment of lookup table 1300 provided using vector registers. For example, the vector registers may reside in a VPU, such as VPU 318. Lookup table 1300 may be a piecewise linear approximation lookup table. Lookup table 1300 may utilize activation approximation compute (AACR) block 1310. AACR block 1301 includes vector register file 1320 and logic 1330. Vector register file (VRF) 1320 includes registers 1322-0 through 1322-31 (generically or collectively 1322), each of which may store an entry or entries for lookup table 1310. In some embodiments, VRF 1320 is part of a VPU such as VPU 318. For simplicity, VRF 1320 is indicated as being part of lookup table 1300. However, lookup table 1300 only utilizes two of registers 1322. Logic 1330 includes a register 1332, address generation logic 1334, parallel lookup logic 1336 and multiply and add unit 1338. Register 1332 may be a custom register storing control parameters for lookup table 1300. For example, the control parameters may be used to deal with negative values in a symmetric approximation of half of the activation function and/or to set range value for which input values are set to the asymptote of the activation function. Address generation logic may be used to determine which of registers 1322 is to be accessed for a given value of a VMM output. Thus, address generation logic 1334 may determine the index for a particular value of the VMM output. Parallel lookup logic 1336 looks up and returns data in registers 1322. Thus, parallel lookup logic returns m (slope) and c (intercept) described herein. In some embodiments, a logic tree is used to pair the address of each activation with the stored coefficients in 1 cycle and move them to multiply and add unit 1338. Multiply and add unit 1338 multiplies the slope by the value of the output of the VMM and adds the intercept. Thus, the output of multiply and add unit 1338 is the activation function applied to the value of the output of the VMM. Thus, lookup table 1310 may use a single VRF 1320. In some cases, a GP processor includes thirty-two VRs. Thus, one or two VRs may be allocated to lookup table(s). This allows for efficient storage of data and efficient calculation of activation functions while retaining enough VRs for the VPU that performance of the GP processor is not adversely affected by the presence of the lookup table.

FIG. 14 is a flow chart depicting one embodiment of method 1400 for using instructions to apply an activation function using a lookup table, such as lookup table 1300. In some embodiments, lookup table 1300 may be configured at 1202 and method 1400 may be analogous to 1204 of method 1200. For clarity, only some steps are shown and/or some steps may have substeps. Further, some steps may be performed in a different order, including in parallel. Method 1400 may start after the resultant(s) of the VMM(s) from compute engine(s) have been moved to the GP processor. Method 1400 may also start after lookup table 1300 has been configured. In some cases, the resultant(s) may be moved to the GP processor between steps of method 1400. The flow of data described in method 1400 is for exemplary purposes only and is not intended to limit the use of the instructions for the lookup table. As indicated, method 1400 may be used in connection with a GP processor which is configured to communicate with a single co-processor or compute engine. Although lookup table 1300 and method 1400 are described together, in some embodiments another method may be used with lookup table 1300 and/or another lookup table may be used with method 1400.

Referring to FIGS. 13 and 14, lookup table 1300 may have already been configured at 1202 of method 1200. Thus, one of vector registers 1322 store the slope and intercept for the desired activation function. For explanatory purposes, it is assumed that vector register 1322-2 stores the slope and intercept and that each entry of register 1322-2 stores eight bits of slope (m) and eight bits intercept (c). Thus, each entry of register 1322-2 stores the slope and intercept for a particular range of output VMM values of the activation function. In another case, another register may store the data for lookup table 1300. Further, in another embodiment, multiple registers might be used to store data for lookup table 1300.

It is determined whether to use lookup table for the activation function, at 1402. For example, in some cases, applying the activation function and/or performing other operations may be applied with lower latency in another manner. For example, in some embodiments, operations such as an addition, a multiplication, and a rectified linear unit (ReLU) may be performed using a VPU such as VPU 318. Operations such as a sigmoid, tanh, sigmoid linear unit (SiLU), and Gaussian error linear unit (GeLU) may be more efficiently performed using lookup table 1300. In some embodiments, a Softmax may use a VPU (e.g. VPU 318) and lookup table 1300. In such cases, 1402 indicates that the lookup table is used for activations sigmoid, tanh, SiLU, GeLU, and Softmax. If it is determined that lookup table 1300 is not used, then the VPU of the GP processor (e.g. VPU 318 of GP processor 310) may be used to apply the activation function to the output of the VMM, at 1404. 1402 may be performed once per activation function. Either 1404 or 1406, 1408, and 1410 are then performed for the values of the VMM output.

If it is determined in 1402 that lookup table 1300 is to be used, then 1404, 1406, and 1410 may be performed. In some embodiments, 1406, 1408, and 1410 may be considered to be performed in response to an instruction indicating that the lookup table is to be used. The appropriate address in the lookup table 1300 for the value of the VMM output is determined, at 1406. Address generation logic 1334 may determine the address of the entries of register 1322-2 (which stores data for the lookup table in this example) based on the range in which the value of the output of the VMM resides. The data for the activation function are obtained from lookup table 1300, at 1408. For example, the coefficients m and c for a piecewise linear lookup table may be obtained from lookup table 1300 at 1408. To do so, parallel lookup logic 1336 may access the appropriate entry of the appropriate register 1322-2, return the slope and intercept (m and c), and provide the values to multiply and add unit 1338. The value of the activation function for the output of the VMM is determined, at 1410. For example, multiply and add unit 1338 may multiply the VMM output by m and add c. Thus, the resultant of the activation function applied to the output of the VMM may be efficiently determined.

Thus, using the instructions described in the context of methods 1100, 1220, and 1400, compute tiles 100, 200, and/or 300, compute engines 110, 210, 310, 400, and/or 500, and lookup table 1300, performance may be improved. In particular, data may be efficiently moved between the GP processor and the compute tiles. Further, nonlinear operations performed by GP processor may be more efficient. Accordingly, performance may be improved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
executing, by a general-purpose (GP) processor configured to communicate with a single co-processor, an instruction identifying a first compute engine of a plurality of compute engines to the GP processor, each of the plurality of compute engines including a compute-in-memory (CIM) hardware module, the CIM hardware module configured to store a plurality of weights corresponding to a matrix in a plurality of storage cells and configured to perform a vector-matrix multiplication (VMM) of a vector and the matrix, the plurality of compute engines being coupled with the GP processor;
at least one of writing first data to or loading the first data from the first compute engine by the GP processor, the first data being for at least one of the plurality of weights, the vector, or a first output of the VMM of the vector and the matrix for the first compute engine;
executing, by the GP processor, the instruction identifying a second compute engine of the plurality of compute engines to the GP processor after the at least one of the writing first data to or the loading the first data from the first compute engine by the GP processor; and
at least one of writing second data to or loading the second data from the second compute engine by the GP processor, the second data being for at least one of the plurality of weights, the vector, or a second output of the VMM of the vector and the matrix for the second compute engine;
wherein the GP processor provides control and data movement for the plurality of compute engines.

2. The method of claim 1, wherein the executing the instruction identifying the first compute engine further includes:
identifying a first address range of the first compute engine to the GP processor for the data movement; and
wherein the at least one of the writing the first data to or the loading the first data from the first compute engine further includes at least one of writing the first data to or loading the first data from the first address range of the first compute engine by the GP processor.

3. The method of claim 1, wherein the at least one of the writing the first data to or the loading the first data from the first compute engine includes writing the first data to the first compute engine, the method further comprising:
executing, by the GP processor, the instruction identifying the first compute engine after the at least one of the writing the second data to or the loading the second data from the second compute engine; and
loading third data from the first compute engine by the GP processor, the third data being for the output of the VMM of the vector and the matrix.

4. The method of claim 3, further comprising:
polling, by the GP processor, the first compute engine after the executing the instruction identifying the first compute engine and after the at least one of the writing the second data to or the loading the second data; and wherein the loading the third data further includes
loading the third data from the first compute engine by the GP processor in response to the polling indicating the third data is available for loading.

5. The method of claim 1, further comprising:
applying, by the GP processor to the first data from the first compute engine, an activation function.

6. The method of claim 5, wherein the applying the activation function further includes:
determining a resultant of the activation function applied to the first data based on information in a lookup table.

7. The method of claim 6, wherein the GP processor includes a plurality of vector registers, the applying the activation function further comprising:
configuring the lookup table such that the lookup table resides in not more than two registers of the plurality of vector registers.

8. The method of claim 7, wherein the lookup table is a piece-wise linear approximation lookup table.

9. A method, comprising:
executing, by a general-purpose (GP) processor configured to communicate with a single co-processor, an instruction identifying a first address range of a first compute engine of a plurality of compute engines for data movement using the GP processor, each of the plurality of compute engines including a compute-in-memory (CIM) hardware module, the CIM hardware module configured to store a plurality of weights corresponding to a matrix in a plurality of storage cells and configured to perform a vector-matrix multiplication (VMM) of a vector and the matrix;
at least one of writing first data to or loading the first data from the first address range corresponding to the first compute engine by the GP processor, the first data being for at least one of the plurality of weights, the vector, or a first output of the VMM of the vector and the matrix for the first compute engine;
executing, by the GP processor, the instruction identifying a second address range for a second compute engine of the plurality of compute engines;
at least one of writing second data to or loading the second data from the second address range corresponding to the second compute engine by the GP processor, the second data being for at least one of the plurality of weights, the vector, or a second output of the VMM of the vector and the matrix for the second compute engine;
executing, by the GP processor, the instruction identifying a third address range for the first compute engine after the at least one of the writing the second data to or the loading the second data from the second address range;
loading third data from the third address range by the GP processor, the third data being for the output of the VMM of the vector and the matrix for the first compute engine; and
applying, by the GP processor to the third data from the third address range of the first compute engine, an activation function using a lookup table.

10. A compute tile, comprising:
a plurality of compute engines, each of the plurality of compute engines including a compute-in-memory (CIM) hardware module, the CIM hardware module storing a plurality of weights corresponding to a matrix and configured to perform a vector-matrix multiplication (VMM) for the matrix; and
a general-purpose (GP) processor coupled with the plurality of compute engines and configured to provide control instructions and data to the plurality of compute engines, wherein the GP processor is configured to:
execute an instruction identifying a first compute engine of a plurality of compute engines to the GP processor;
at least one of write first data to or load the first data from the first compute engine, the first data being for at least one of the plurality of weights, the vector, or a first output of the VMM of the vector and the matrix for the first compute engine;
execute the instruction identifying a second compute engine of the plurality of compute engines to the GP processor after the at least one of writing first data to or loading the first data from the first compute engine; and
at least one of write second data to or load the second data from the second compute engine, the second data being for at least one of the plurality of weights, the vector, or a second output of the VMM of the vector and the matrix for the second compute engine;
wherein the GP processor provides control and data movement for the plurality of compute engines.

11. The compute tile of claim 10, wherein to execute the instruction identifying the first compute engine, the GP processor is further configured to:
identify a first address range of the first compute engine to the GP processor for the data movement; and
wherein to perform the at least one of write the first data to or load the first data from the first compute engine, the GP processor is further configured to at least one of write the first data to or load the first data from the first address range of the first compute engine.

12. The compute tile of claim 10, wherein the GP processor writes the first data to the first compute engine and wherein the GP processor is further configured to:
execute the instruction identifying the first compute engine after the at least one of writing the second data to or loading the second data from the second compute engine; and
load third data from the first compute engine, the third data being for the output of the VMM of the vector and the matrix.

13. The compute tile of claim 12, wherein the GP processor is further configured to:
poll the first compute engine after executing the instruction identifying the first compute engine and after the at least one of the writing the second data to or the loading the second data;
and wherein to load the third data further includes the GP processor is further configured to load the third data from the first compute engine by the GP processor in response to a response to the polling indicating the third data is available for loading.

14. The compute tile of claim 13, wherein the GP processor is coupled with the plurality of compute engines via a streaming port and a command port, the streaming port being configured to exchange data between the GP processor and the plurality of compute engines, the command port being configured for the GP processor to send commands the plurality of compute engines.

15. The compute tile of claim 10, wherein the GP processor is further configured to:
apply to the first data from the first compute engine, an activation function.

16. The compute tile of claim 15, wherein to apply the activation function, the GP processor is further configured to:
determine a resultant of the activation function applied to the first data based on information in a lookup table.

17. The compute tile of claim 16, wherein the GP processor includes a plurality of vector registers, and wherein the GP processor is further configured to:
configure the lookup table such that the lookup table resides in not more than two registers of the plurality of vector registers.

18. The compute tile of claim 17, wherein the lookup table is a piece-wise linear approximation lookup table.

19. The compute tile of claim 16, wherein the lookup table is in the GP processor.

20. The compute tile of claim 10, wherein the GP processor is coupled with the plurality of compute engines via a streaming port configured to exchange data between the GP processor and the plurality of compute engines.
